(19) United States
(12) Patent Application Publication
(10) Pub. No.: US 2007/0299965 A1
(43) Pub. Date: Dec. 27, 2007

(54) Management of client perceived page view response time

(76) Inventors: Jason Nieh, New York, NY (US); David P. Olshefski, Danbury, CT (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/472,691

(22) Filed: Jun. 22, 2006

(51) Int. Cl. G06F 15/173

(52) U.S. Cl. 709/224; 709/223

(57) ABSTRACT

A system and method for managing perceived response time includes transmitting a request or response. If the request or response is dropped, response time is managed by providing a retransmission from a response time manager, without the response time manager satisfying the request or response. The response time manager is located between a client and a server.

### BACKGROUND

1. Technical Field

The present invention relates to network communications and more particularly to a system and method for managing perceived response time for clients using online services.

2. Description of the Related Art

For many businesses the World Wide Web is a highly competitive environment. Customers seeking quality online services have choices, and often the characteristic that distinguishes a successful site from the rest is responsiveness. Clients are keenly aware when response time exceeds acceptable thresholds and are not hesitant to take their business elsewhere. It is therefore important for businesses to manage the response time that their clients are experiencing.

Unfortunately, the quality of service (QoS) approaches which have been developed over the years by the research and Internet service communities have not sufficiently addressed the problems associated with managing client perceived response time. The focus of existing work has been on achieving service level agreements which are defined in terms of server processing latency for an individual URL request. What has failed to capture the attention of QoS management is the fundamental idea that when a remote client visits a web site, he downloads a page which consists of multiple objects. It is the response time for downloading an entire page view (the container page and all the embedded objects) that is the latency perceived by the client.

In prior work of the present inventor, ksniffer was developed, which is a kernel-based traffic monitor capable of determining page view response times, as perceived by the remote client, in real-time at gigabit traffic rates. Ksniffer functioned as a measurement system.

Almost without exception, research into applying admissions control (load shedding) for managing web server latencies has ignored the effect of dropping a request on the page view response time experienced by the remote client. Dropped requests are ignored while the server response time for the individual URL requests that gain acceptance is reported.

### SUMMARY

In accordance with present embodiments, a response time manager, such as, a ksniffer having its functionality extended from merely a measurement system to a system with latency management capabilities is provided. In one embodiment, a response time manager is employed as a stand-alone appliance which sits in front of a server complex to actively manipulate the packet stream between client and server to achieve a desired result at the remote client browser. The response time manager does not need to modify Web pages, the server complex, or browsers, making deployment quick and easy. This is particularly useful for Web hosting companies responsible for maintaining the infrastructure surrounding a Web site, but are not permitted to modify the customer's server machines or content.

One contribution of this disclosure defines and includes the effect of connection admission control drops on partially successful web page downloads. This led to uncover some notable behaviors of web browsers in the presence of connection failures. Likewise, admission control drops can be shown to have a significant effect not only on the mean response time, but also on the shape of the response time distribution. Managing the response time distribution is an important aspect as controlling only the mean while ignoring the variance can misrepresent the service provided by the server complex.

Response time is measured and shown why it is relevant to the remote client. An approach for tracking and managing a page view download, in real-time as it is being downloaded, is illustratively described. Novel control mechanisms are applied at key junctures during the page view download, and the effects they have on the remote client browser are described. Experimental results are presented.

A system and method for managing perceived response time includes transmitting a request or response. If the request or response is dropped, response time is managed by providing a retransmission from a response time manager, without the response time manager satisfying the request or response. The response time manager is located between a client and a server.

Another method for managing perceived response time includes tracking progress of downloading of an entire page as each of a plurality of objects is downloaded, and managing response latency using a response time manager to control perceived response time based upon download latencies of portions of the entire page.

A system for managing perceived response time includes a response time manager disposed between a network and a server. The response time manager is configured to manage perceived response time by retransmitting a dropped response or request. A response module is included in the response manager and configured to monitor perceived response times of a client and make adjustments to processing of requests or responses to reduce overall latency.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a schematic block diagram showing the placement of a response time manager (e.g., an extended ksniffer) in accordance with one illustrative embodiment;

FIG. 2 is a diagram, showing the downloading of a container page and embedded objects over multiple connection in accordance with one illustration;

FIG. 3 is a diagram, showing a breakdown of client response time in accordance with another illustration;

FIG. 4 is an event node graph showing a page view model for events in a client server interaction;

FIG. 5 is a diagram, showing SYN drops at a server in accordance with another illustration;

FIG. 6 is a diagram, showing a second connection in a page download failing in accordance with another illustration;

FIG. 7 is a diagram, showing a fast SYN transmission in accordance with one illustrative embodiment;

FIG. 8 is a diagram, showing an effect of dropping a SYN/ACK in accordance with one illustration;

FIG. 9 is a diagram, showing a fast SYN/ACK retransmission in accordance with one illustrative embodiment;

FIG. 10 is a plot of a Cardwell transfer latency function for 80 ms and 2% loss rate;

FIG. 11 is a block/flow diagram showing a method for managing perceived latency in accordance with an illustrative embodiment;

FIG. 12 is a block/flow diagram showing a system for managing perceived latency in accordance with an illustrative embodiment;

FIG. 13 is a schematic diagram showing a testbed used in experimentation in accordance with the present principles;

FIGS. 14-18, 20, 24, 25, 28 show probability distribution functions (PDF) versus response time under a plurality of different conditions; and

FIGS. 19, 21-23, 26, 27, and 29 show cumulative distribution functions (CDF) versus response time under a plurality of different conditions.

### DETAILED DESCRIPTION OF PREFERRED EMBODIMENTS

In accordance with illustrative embodiments, a Remote Latency-based Management (RLM) system, which includes a novel approach for managing the client perceived response time of a web server, will be described. Remote Latency-based Management (RLM) indicates a focus on managing the remote client perceived response time. RLM is different from existing approaches in several ways. First, the RLM approach manages the response time as perceived by the remote client for an entire page download. Existing approaches manage the server latency associated with processing a single URL request. Second, the present approach takes into account the effect which admissions control rejects has on the remote client response time. Existing approaches which perform load shedding ignore the impact a dropped request has on the response time of the page view, reporting results in terms of only accepted URL requests. In this vein, some notable effects are uncovered that occur in web browsers under conditions of connection failures, and a novel mechanism is introduced. This mechanism, fast SYN and fast SYN/ACK retransmission, can be used in the context of load shedding and lossy connections to combat the previously referred to effects.

Third, the present system tracks the progress of each page download in real-time, as each embedded object is requested, allowing the present system to make fine grained decisions on the processing of each request as it pertains to the overall page view latency. Existing approaches place a URL request into a service class, oblivious of the context in which the object is being downloaded. The approach presented herein is non-invasive and manipulates the latencies experienced at the remote web browser by manipulating the packet traffic in/out of a server complex. As such, this approach requires no changes to existing systems. Experimental results demonstrating the key issues and the effectiveness of the present techniques are provided.

Embodiments of the present invention can take the form of an entirely hardware embodiment, an entirely software embodiment or an embodiment including both hardware and software elements. In a preferred embodiment, the present invention is implemented in a combination of hardware and software. The software includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

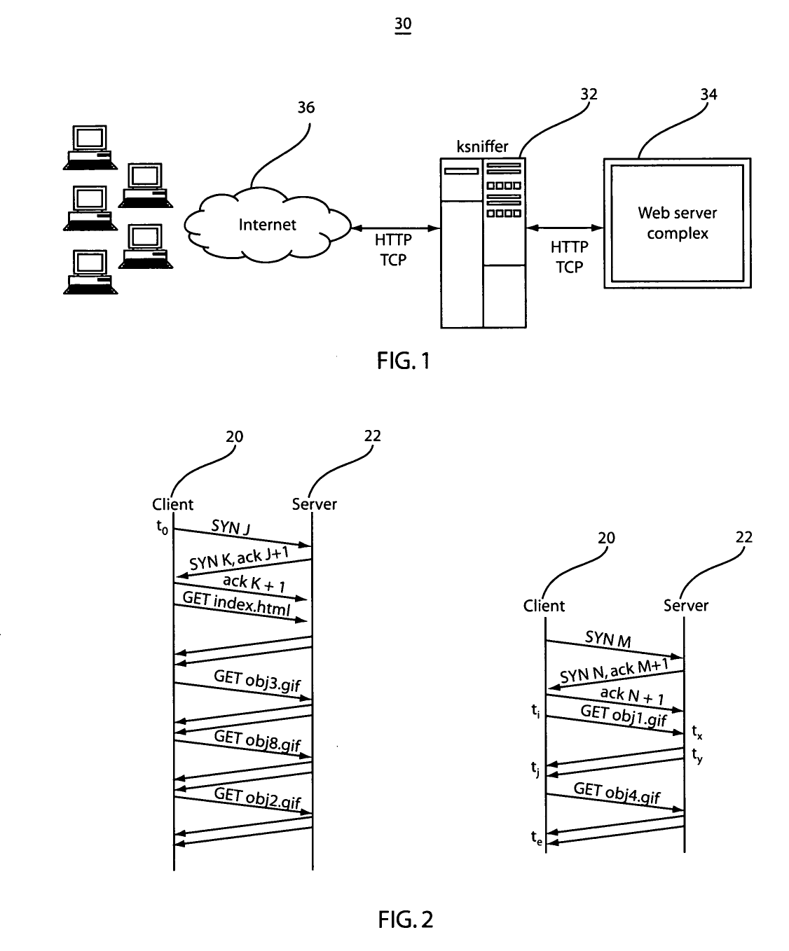

Referring now to the drawings in which like numerals represent the same or similar elements and initially to FIG. 1, an exemplary system 30 is illustrative shown. System 30 includes a response time manager 32 for measuring response time. Response time manager 32 is connected between a web server 34 and a network 36, such as the Internet. One challenge when faced with managing the client perceived response time is to accurately measure it. There is no industry-wide standard method for measuring response time, and as such, a wide variety of latency measurements have emerged, most of which are based on measuring the server latency to process a single URL request. In the present approach, a method for measuring the client perceived page view response time may be defined. This is paramount not only for purposes of feedback, control, and validation, but also to ensure that the response time measurement is meaningful with respect to the remote client. The measure of response time may be the time it takes for a remote client to download an HTML file and all its embedded objects. The beginning of response time is defined as the moment the initial SYN packet is transmitted from the client, and the end of the response time is defined as the moment at which the client receives the last byte for the last embedded object within the page.

Referring to FIG. 2, a diagram showing interaction between a client 20 and a server 22 are illustratively shown. In particular, downloading a container page and embedded objects over multiple connections is shown. A client perceived response time is tₑ−tₒ. This assumes that the client 20 did not have an existing open connection to the web server 22. If such a connection existed, then the client 20 could reuse the connection and the beginning of a page view response time would be indicated by the transmission of a GET request for index.html. It is to be understood that in the FIGS. SYN, ACK and GET are known actions/responses and represent synchronize, acknowledge and get, respectively. Also, indexes, e.g., J, K, M, N and object names, e.g., obj3, obj8, etc. are employed in the FIG. descriptions.

In FIG. 2, note that this measure of response time does not include DNS lookup time incurred at the client 20 prior to connecting to the server 22, nor does it include the time it takes a client browser to render images on the display after the last byte for the last embedded object is received by the client 20 (rendering times can be measured offline using a tool such as, e.g., PAGEDETAILER™.

The measure of response time does include the TCP connection establishment latency, which may be important to capture, especially in the presence of admissions control. Obtaining this measure of response time needs tracking the client-server interaction at the packet level. As such, mechanisms which attempt to measure response time via timestamping server-side user-space events do not measure client perceived response time. For example, measuring response time within Apache™ when a request arrives (i.e. t_{y}−tₓ) ignores the TCP 3-way shake that occurs to establish the connection, as well as time spent in kernel queues before the request is given to apache.

Such Apache™ level measurements have been shown to be as much as an order of magnitude less than the response time experienced by the remote client. Likewise, measuring the time needed to service a single URL (i.e. tⱼ−tᵢ) is simply not relevant to the remote client who is downloading not just a single URL but an entire page view. As such, it is the client perceived response time associated with an entire page view that is sought to be managed.

RT will be employed hereinafter as shorthand for remote client perceived page view response time. Response time manager 32 (FIG. 1) tracks the page view response time in an online manner by observing the packet traffic in/out of the web server complex. The TCP and HTTP protocol behavior for remote client is tracked and measured, for all TCP connections and HTTP requests. Multiple HTTP requests, over multiple (non-)persistent TCP connections are correlated such that a response time measurement for a complete page view can be determined. A model of TCP is used to capture round trip time (RTT) and network loss to infer unseen network packet loss, resulting in a more accurate estimate of the remote client perceived response time. Response time manager 32 is not a proxy but rather a high performance, kernel level, real-time packet analyzer. Details of the correlation algorithms and implementation of Response time manager 32 can be found in D. Olshefski et al., “Ksniffer: Determining the Remote Client Perceived Response Time from Live Packet Streams”, 6^{th} Symposium on Operating Systems Design and Implementation (OSDI 2004), pages 333-346, San Francisco, Calif., December 2004, USENIX, incorporated herein by reference.

REMOTE LATENCY-BASED MANAGEMENT: a new model for specifying and achieving RT service level objectives is based on tracking a page view download as the download happens. Service decisions are made at each key juncture based on the current state of the page view download.

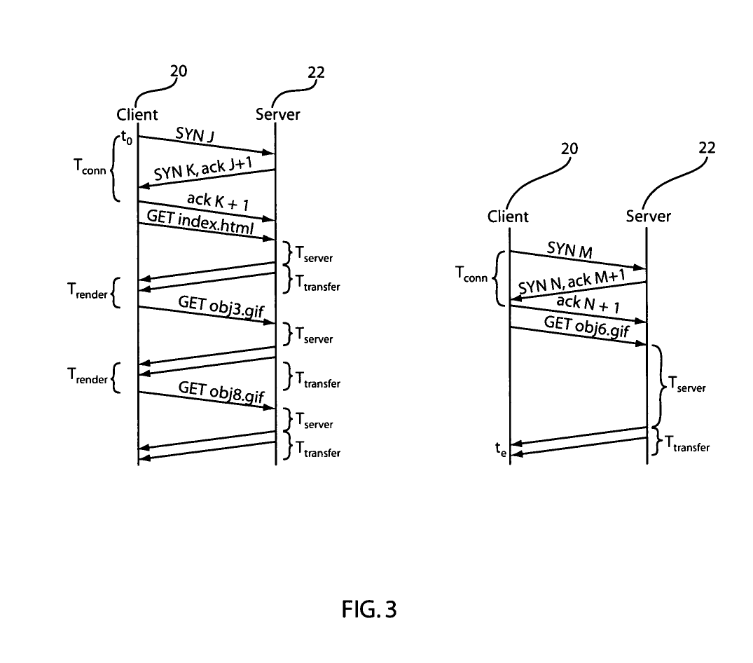

Referring to FIG. 3, a diagram showing a breakdown of response time (RT) for a page view download is illustratively depicted. RT of tₑ−t₀ is shown for a page view download of index.html which embeds obj3.gif, obj6.gif and obj8.gif. The figure is annotated with the following terms.

1. T_{conn} TCP connection establishment latency, using the TCP 3-way handshake. Begins when the client 20 sends the TCP SYN packet to the server 22.

2. Tₛₑᵣᵥₑᵣ latency for server complex to compose the response by opening a file, or calling a common gateway interface (CGI) program or servlet. Begins when the server 22 receives an HTTP request from the client 20.

3. T_{transfer} time needed to transfer the response from the server to the client. Begins when the server 22 sends the HTTP request header to the client 20.

4. T_{render} time needed for the browser to process the response, such as parse the HTML or render the image. Begins when the client 20 receives the last byte of the HTTP response.

Each of these four latencies are serialized over each connection and delimited by a specific event. As such, a page view download can be viewed as a set of well defined activities needed to complete the page view.

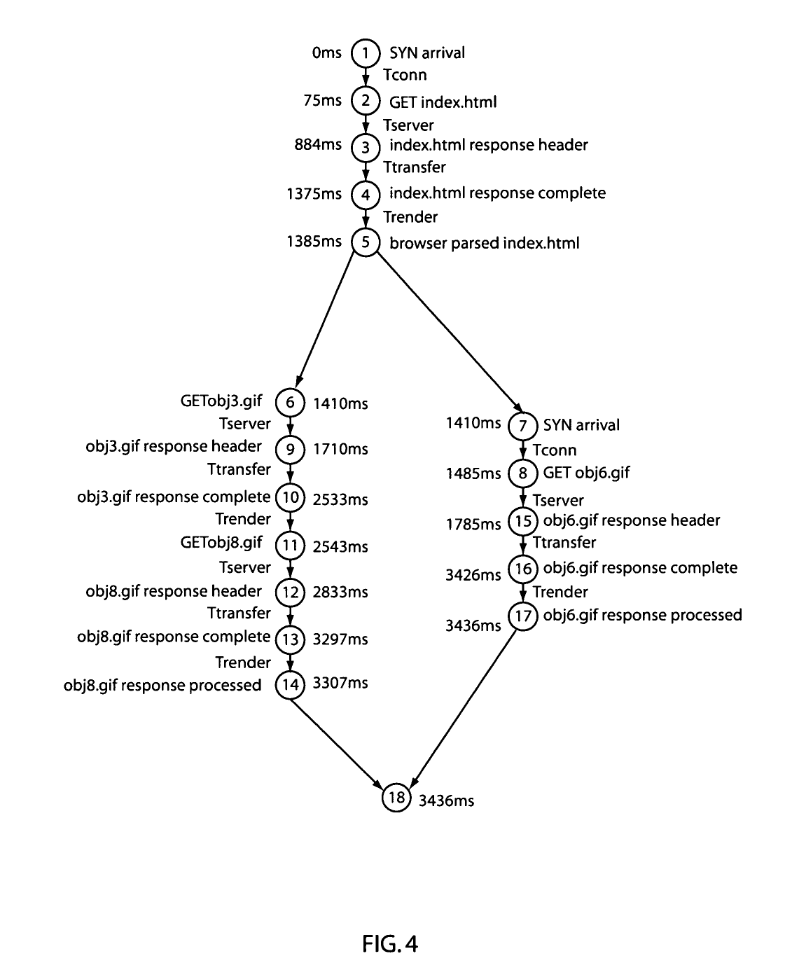

Referring to FIG. 4, the download of FIG. 3 is depicted as an event node graph, where each node (1-18) represents a state, and each link indicates a precedence relationship and is labeled with the transition activity. The nodes 1-18 in the graph are ordered by time and each node is annotated with the elapsed time from the start of the transaction. Each activity contributes to the overall RT; certain activities overlap in time, some activities have greater potential to add larger latencies that others, some activities are on the critical path and some activities are more difficult to control than others. Managing the high latency activities on the critical path is one important factor in the present approach.

What differentiates the present approach from other QoS approaches is, e.g., that response time manager 32 (FIG. 1) decides whether to apply a service mechanism at each point in time within the context of the page view download. The extended response time manager 32 (which already tracks the activity of a page download) makes decisions at each key juncture as to how to manage the next activity. The response time manager 32 is transformed from a strictly passive measurement device to an appliance that actively manipulates the traffic stream to affect the latencies perceived by the remote client.

Web Browsers and Connection Establishment Latency: A great deal of work has been done in applying admissions control to prevent web servers from overloading or to shed the load imposed by low priority tasks so that high priority tasks can achieve shorter processing latencies. What has not been studied with regard to admissions control is the effect that admissions control drops have on the behavior of the remote web browser.

Since the remote client is watching a web browser that is displaying a page view including a container page and a set of embedded objects, it is advantageous to know how exactly load shedding affects the latency perceived by the client viewing the web browser. To answer this question, a series of experiments were performed using Microsoft Internet Explorer™ v6.0 and FireFox™ v.1.02 in which various types of connection rejection was performed by performing SYN drops to emulate an admissions control mechanism at the web server. The end result was that the resulting response time at the browser is greatly affected not only by the number of SYN drops, but also by the connection for which the SYN drops occur.

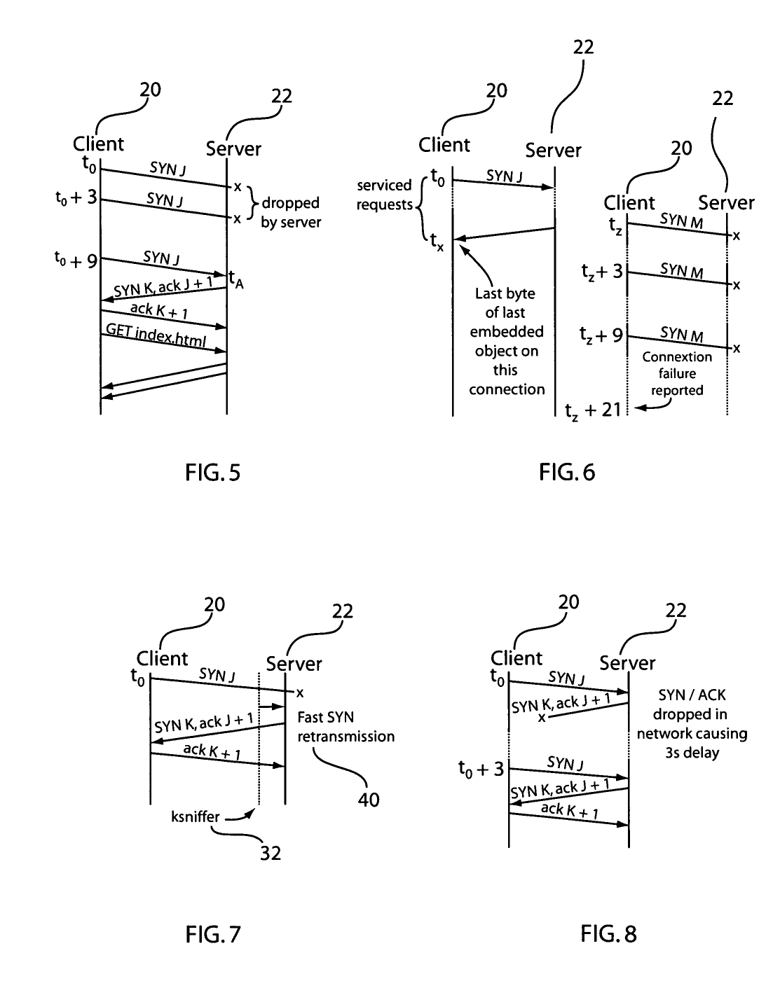

FIG. 2 depicts the well known TCP 3-way handshake used for connection establishment, and FIG. 5 depicts the behavior of TCP under server SYN drops (not drawn to scale). Referring to FIG. 5, the client 20 sends an initial SYN at to, but the server 22 drops this connection request due to admissions control. The client's TCP implementation waits 3 seconds for a response. If no response is received, the client 20 will retransmit the SYN at tₒ+3 s. If that SYN gets dropped, then the next SYN transmission occurs at time t₀+9 s. The timeout period doubles (from 3 s, 6 s, 12 s, etc) until either the connection is established, the client hits stop/refresh on the browser which cancels the connection, or the maximum number of SYN retries is reached. This is the well-known TCP exponential backoff mechanism.

Server SYN drops are not a denial of service, but rather a mechanism for rescheduling the connection into the near future. Although this behavior is effective in shedding load, it has significant effects on the RT perceived by the remote clients. Existing admission control mechanisms which perform SYN throttling simply ignore this effect and report the response time once the connection is accepted, beginning from time t_{A}. Ignoring this effect misrepresents both the client response time and throttling rate at the web site.

The browsers studied open more than one connection to the server, as depicted in FIG. 2. A latency management system, which uses admissions control as a mechanism for load shedding, ought to therefore understand the effect of a SYN drop in the context of which connection is being affected. If only the first SYN on the first connection is dropped, then the client will experience the additional 3 s retransmission delay, but will still be serviced.

Suppose the first connection gets established immediately, but all SYNs on the second connection are dropped by the admissions control mechanism, causing a connection failure to be reported to the browser after 21 s. Our study of web browsers indicates that the browser never retrieves the first object which would have been retrieved on the second connection. This would be obj1.gif in FIG. 2. The browser will retrieve all other objects over the first connection, including those objects which would have been obtained over the second connection had it been established, such as obj4.gif in FIG. 2. Therefore, one embedded object is strictly associated with the second failed connection and is not obtained. This scenario is depicted in FIG. 6.

Referring to FIG. 6, a second connection failure in page downloading is illustratively shown. While the second connection is undergoing SYN drops at the server 22, the client 20 sees an hourglass cursor on his screen, the busy icon in the corner of the browser is spinning, and the progress bar at the bottom of the browser window is showing ‘in progress’. All these indicate that the page is in the process of being downloaded. It is not until TCP reports the connection failure to the browser after 21 s that the page view is done. All the objects which are successfully obtained from the server are obtained over the first connection during the time interval to thru tₓ. The end of the page download occurs at t_{z}+21, when TCP reports a failed connection to the browser.

In addition to the above mentioned reasons, for a partial page download such as this, tₓ cannot be considered the end of the client perceived response time—the one object not retrieved could be a significant portion of the entire page view. Likewise, suppose that the SYN transmitted at t_{z}+9 was accepted by the server, the connection was established, and an object was requested and obtained over that connection. The end of the client perceived response time would have to be the time that the last byte of the response for that object was received by the client 20.

A variety of SYN drop combinations could occur, across multiple connections causing various effects on the client perceived response time. Obviously, if all SYNs on the first connection are dropped, then the client 20 is actually denied access to the server 22. If both connections are established, each after one or more SYN drops, then the TCP exponential backoff mechanism plays an important role in the latency experienced at the remote browser. Of course, the effect becomes more pronounced under HTTP 1.0 without KeepAlive where each URL request needs its own TCP connection. The retrieval of each embedded object faces the possibility of SYN drops and possible connection failure.

Although the majority of browsers use persistent HTTP, the trend for web servers is to close a connection after a single URL request is serviced if the load is high. Apache Tomcat™ behaves in this manner when the number of simultaneous connections is greater than 90% of the configured limit, and reduces the idle time if the number of simultaneous connections is greater than 66%. This, in effect, reduces all transactions to HTTP 1.0 without KeepAlive.

The maximum number of SYN retries that lead to a connection failure is dependent on the operating system being used by the remote browser—this defines the connection timeout. In most situations, the number of SYN retries will not be modified by the client and as such the default configuration will apply, which is 3 for Windows XP systems. After 3 tries are exhausted, the elapsed time would be about 21 seconds. Realistically, few people desire to wait 2 minutes to connect to a web site. No study has been published as to how long people do wait before canceling the page view by hitting stop or refresh. As such, a frustration timeout of 21 s will be used. This means that if a client does not see anything in the browser after 21 s, the client kills the page view download by closing the browser or hitting refresh. This is equivalent to a connection failure being reported to the browser after TCP transmits three SYN packets without receiving a reply from the server. 21 s is also used in our experiments, noting that this is something of a conservative value. To use a larger value, the effect connection failure has on the response time would be greater, exaggerating the benefit of the mechanisms described herein. Other times may also be employed instead of 21 s.

If, on the other hand, the browser is painting the screen in a piece-meal manner, indicating that progress is being made, then it is more likely that clients will tend to read the page view as it slowly gets displayed on the screen. This behavior would occur if SYN drops occur on the second connection. In this situation, the page view response time could exceed 21 s, which is apparent in the distributions depicted herein.

There is a significant, coarse-grained impact that server SYN drops have on the page view response time. A technique can be used to reduce this coarse-grained effect, which will be referred to as fast SYN retransmission and is depicted in FIG. 7.

Referring to FIG. 7, after a server SYN drop, response time manager 32 retransmits the SYN, on behalf of the remote client 20, at shorter time intervals (e.g., 500 ms) than the TCP exponential backoff. Since response time manager 32 resides within the same complex in which the server exists and is not retransmitting the SYNs over a network, it is a locally controlled violation (if at all) of the TCP protocol. The net effect is that a connection is established as soon as the server 22 is able to accept the request. This can smooth the response time distribution, and variations of this basic form can be used to alter the amount of load shedding/connection acceleration performed. Since dropping a SYN at the server needs little processing, the overhead of this approach on the server complex is minimal, even when the server is loaded. Nevertheless, the retransmission gap could be adjusted based on the current load or the number of active simultaneous connections.

SYN/ACKS dropped in the network cause the exact same latency effect as a SYN dropped at the server. From the client perspective, there is no difference between a SYN dropped at the server and a SYN/ACK dropped in the network—a SYN/ACK does not arrive at the client and the TCP exponential backoff mechanism applies. FIG. 8 shows this effect.

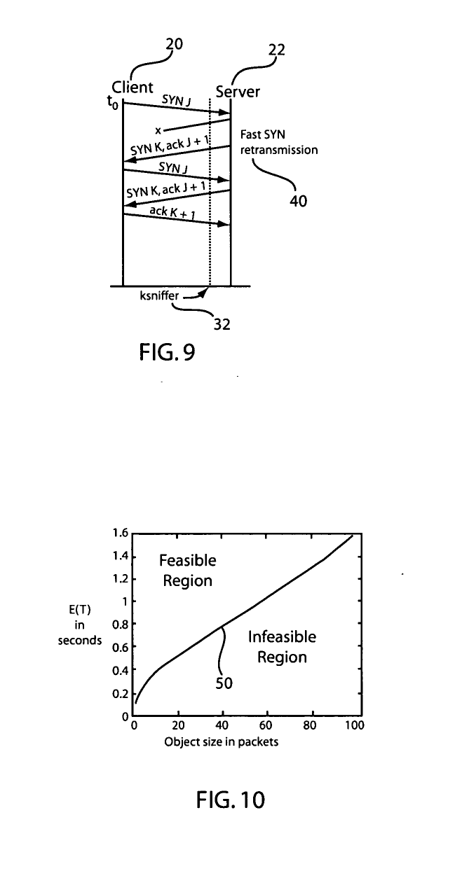

Referring to FIG. 9, response time manager 32 is enabled to retransmit the SYN/ACK, on behalf of the server 22, if it does not capture an ACK from the client 20 within a timeout much smaller than the exponential backoff (e.g., 500 ms). The response time manager 32 provides fast SYN/ACK retransmission mechanism 40. Fast SYN/ACK retransmission 40 clearly violates the TCP protocol by performing retransmissions using a shorter retransmission timeout period than the exponential backoff. One can make several arguments that this is a minor divergence from the protocol. On the other hand, an Internet web site which uses this technique to improve connection latency can rightly be labeled as an unfair participant on the Internet. If deployed, the overhead, either in the network or in the remote client is minimal. This technique can alleviate some of the latency experienced by remote clients with lossy connections to the web server.

Referring again to FIG. 4, both the fast SYN and fast SYN/ACK retransmission technique are applied during state transitions 1→2 and 7→8 to reduce the critical path connection latency.

Transfer Latency: Much work has been done in applying scheduling and bandwidth allocation to control TCP transfer latency, both at the end host and in the network. In such cases, the end host or network device is a bottleneck where long queuing delays are experienced. More recently, however, work has been done on reducing the size of the response to manage response time. In such cases the network connection between client and host is the latency bottleneck, T_{transfer} is known to be a function of object size, RTT and loss rate: T_{transfer}=f(size, RTT, loss) (1) where f( ) is Cardwell's transfer latency function.

Several analytic models of f(size,RTT,loss) have been developed. For example, Padhye et al. in “Modeling TCP Throughput: A Simple Model and Its Empirical Validation”, ACM SIGCOMM Computer Communication Review, 28(4):303-314, 1988, developed a transfer latency function for modeling latencies of TCP bulk transfer (i.e. steady-state). Cardwell et al. in “Modeling TCP Latency”, IEEE INFOCOMM, vol. 3, pages 1742-1751, 2000, extended this model to include short lived TCP flows, which are typical of a web server transaction. Sikdar et al. in “Analytic Models and Comparative Study of the Latency and Steady-State Throughput of TCP Tahoe, Reno and Sack”, IEEE GLOBECOMM, pages 100-110, San Antonio, Tex., November 2001, have also developed a model for short-lived TCP flows.

Referring to FIG. 10, a transfer latency function defined by Cardwell et al., for an RTT of 80 ms and loss rate of 2% is illustratively depicted. A line 50 indicates the expected time (y-axis) it will take to transfer an object of the given size (x-axis). For smaller objects (in this case less than 10 packets in size) the transfer latency is dominated by TCP slow start behavior, which is depicted as having a logarithmic shape. For larger objects, the transfer latency is dominated by TCP stead-state behavior (the near-linear portion of the graph). Note that Cardwell's function is not a model of the minimum amount of time required, but rather the expected amount of time. Therefore, the model assumes that some transactions will take more or less time, with the expectation that most transactions will be on or near the line. The farther a point is from the line, the less likely of it occurring in practice. For example, it is extremely unlikely that an object of size 50 packets can ever be transferred in under 1 second if the RTT is 80 ms and the loss rate is 2%.

The region below the line is labeled as infeasible. Although it is not entirely impossible for such latencies to be observed, they are highly unlikely to occur. The model predicts that under higher loss rates and longer RTT, reducing object size can reduce T_{transfer} by half.

Assuming that both RTT and loss rate are a function of the end to end path from client to server through the Internet and therefore uncontrollable, the web server is left with varying the response size as a control mechanism for affecting the T_{transfer} latency. The following capabilities were implemented within response time manager 32 as mechanisms for controlling the size of the response from the server to the client:

1. Translate a request for a large image into a request for a smaller image: Capture the HTTP request packet, if the request is for a large image then modify the request packet by overwriting the URL so that is specifies a smaller image, and then pass the request onto the server.

2. Remove references to embedded objects from container pages: Capture the HTTP response packets, if the response is for a container page then modify the response packet by overwriting references to embedded objects with blanks, and then pass the request packet onto the client.

In the first technique the size of the response is greatly reduced resulting in a reduction of the T_{transfer} latency for that embedded object, a reduction in Tₛₑᵣᵥₑᵣ on the server, and a reduction in T_{render} at the remote browser. An object is returned, but it is of much smaller size. In this case the quality of the content is affected since the remote client sees a smaller gif instead of the full size image. By modifying the client to server HTTP request, response time manager 32 can decide on a per request basis, during the middle of a page view download, whether or not to change the requested object size. This presumes the existence of smaller objects—for some web sites, maintaining all or some of their images in two or more sizes may not be possible. This technique can also be applied to dynamic content, where a less computationally expensive common gateway interface (CGI) is executed in place of the original, or the arguments to the CGI are modified (i.e. a search request has its arguments changed to return at most 25 items instead of 200).

In the second technique, the T_{transfer}, Tₛₑᵣᵥₑᵣ, and T_{render} latency are entirely eliminated since the embedded object is completely removed from the container page. Possibly T_{conn} is also eliminated for the second connection, if the second connection was not already established. This has a greater load shedding and latency reduction effect than the first technique, but the quality of the content viewed by the remote client can be severely affected. Instead of viewing thumbnail images, the client only sees text. Unlike the first technique which can be applied for any image retrieval during page view download, the decision as to whether or not to blank out the embedded gifs in the container page can only be made at one point in the page view download—when the container page is being sent from the server to the client, which is transition 3→4 in FIG. 4.

Like fast SYN and fast SYN/ACK retransmission, these techniques do not require changes to existing server systems. These techniques do not require that response time manager keep buffers of packet content to be applied. Response time manager 32 only modifies a packet and forwards the modified version. If the modification cannot be applied to a single packet, then it is not. For example, if a request for an embedded object is found to cross a packet boundary (e.g., not be wholly contained within a single packet), response time manager 32 will not blank out the reference (although, adding this capability is conceptually not difficult). Response time manager 32 is not a proxy (the response time manager is not a TCP endpoint), and as such, it ensures the consistency of the sequence space for each connection. This means that changing the HTTP request/response is constrained by the size and amount of white space in each packet.

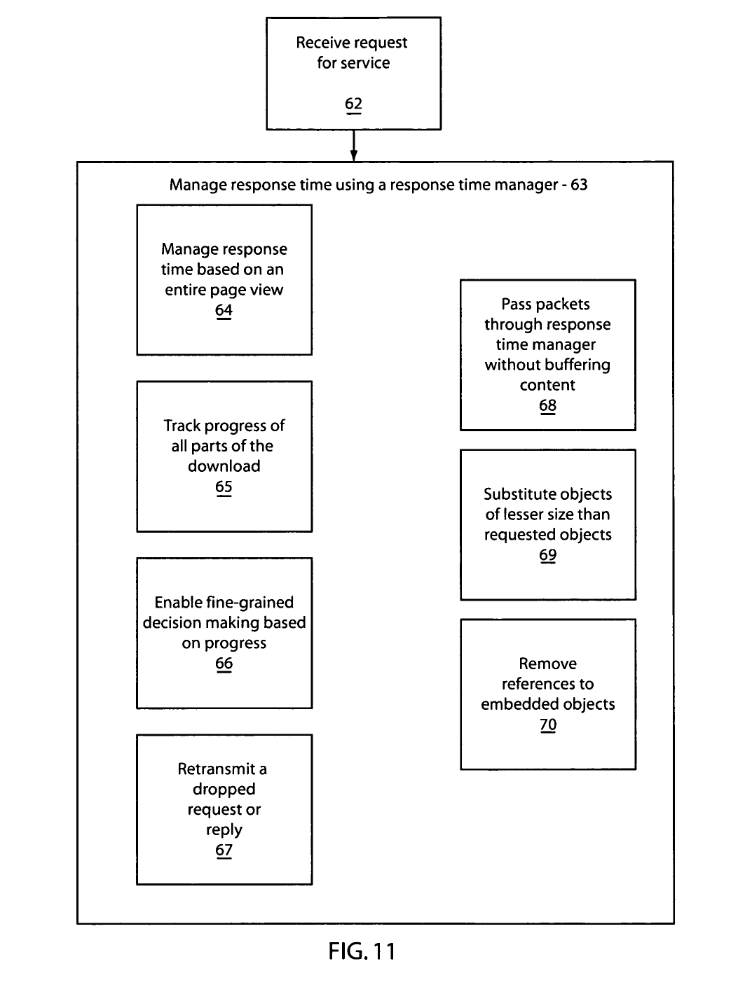

Referring to FIG. 11, a method for managing perceived response time includes transmitting a request or response. For example, a request for a connection, acknowledgement, GET, etc. or a response therefore, in block 62. In block 63, if the request or response cannot be immediately handled or is dropped, a response time is managed or controlled by a response time manager, without the response time manager satisfying the request or response. The response time manager is preferably located in front of the server to perform an action on the request when the request or response is dropped e.g., by the server (or the client). Management of actual response time in block 63 may be managed in a plurality of ways. These ways may include one or more of the following in blocks 64-70.

In block 64, managing the response time is performed based on downloading of an entire page or more than one object. In block 65, progress of the downloading is tracked for the entire page as each of a plurality of objects is downloaded. Fine-grained decisions about the response time can be made by the response time manager to reduce perceived response time based upon download latencies of portions of the entire page in block 66.

In block 67, response time may be managed by providing a retransmission from a response time manager, without the response time manager satisfying the request or response. The retransmitting may include resending the dropped request (or response) from the response time manager. This may include, e.g., a fast SYN/ACK retransmission on behalf of the server, where the retransmission timeout is less than a standard exponential backoff time or any other action in accordance with the present principles.

Packets received by the response time manager are passed through. In block 68, packets sent between the client and the server may or may not be modified and if modified, a modified version is forwarded. In block 69, substituting objects of lesser size for requested objects of larger size may be performed. In block 70, removing references from the request for at least one embedded objects may be employed to manage latency.

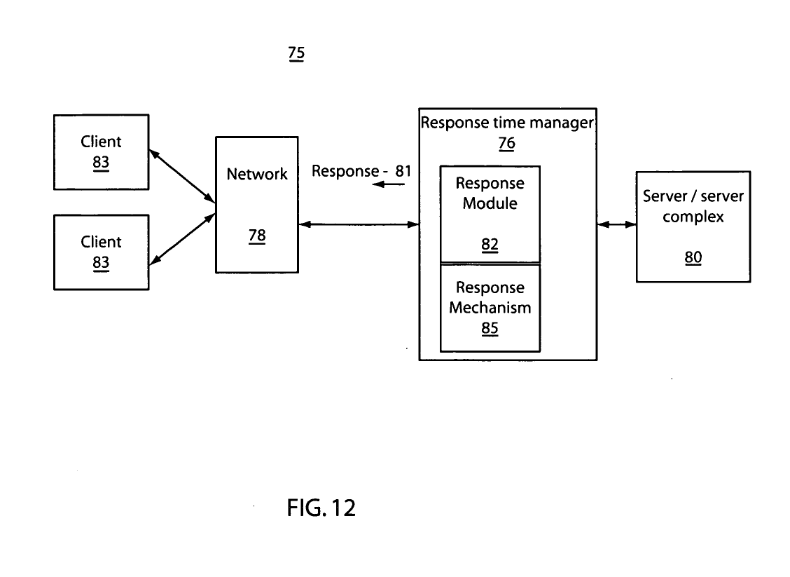

Referring to FIG. 12, a system 75 for managing perceived response time includes a response time manager 76 (equivalent to response time manager 32) disposed between a network 78 and a server or server complex 80. The response time manager 76 is configured to manage perceived response times by providing a response 81 to one or more client requests and performing an action on the request when the server 80 drops a request. The response time manager 76 is preferably located in front of the server 80 on a server side and manipulates a packet stream between the server 80 and a client or clients 83 to manage packets therebetween to achieve a reduction in perceived client latency.

A response module 82 is included in the response manager 76 and is configured to monitor perceived response times of the client 83 (e.g., a seen on a web browser) on the network 78. The response module 82 measures response times, access times, etc. and makes adjustments to processing of requests and portions of requests to reduce overall page view latency as perceived by the client 83.

In one embodiment, the response module 82 is configured to track progress for downloading of an entire page as each of a plurality of objects is downloaded. The response manager 83 makes decisions to reduce perceived response times based upon download latencies of portions of the entire page. The response time manager 76 provides a plurality of actions which are employed at preset junctures (e.g., the request for an embedded object in a page or at a response time for a handshake, etc.) in a communication session between the client 83 and the server 80. The perceived reduction in latency may be provided in a plurality of ways, which may be used independently or in combination.

In addition, response module 82 may include one or more response mechanisms 85, which may be triggered to transmit a response on behalf of the client 83 or the server 80. Examples of response mechanisms include a fast SYN retransmission on behalf of the client, where the retransmission timeout is less than an exponential backoff time, a fast SYN/ACK retransmission on behalf of the server, where the retransmission timeout is less than an exponential backoff time, etc.

The response module 82 may perform other actions to reduce perceived latency by the client 83. For example, the response module 82 may substitute objects of lesser size for requested objects of larger size, or remove references from the response or portions of the response for at least one embedded object.

Experimental Results:

Results obtained when applying the present techniques in an experimental setting are presented using a TPC-W workload. We experimented under both the single-class and multi-class environment and report on their effectiveness in both. We note that several of our techniques act as both load shedding and response time accelerators; albeit for a tradeoff in the quality of the content returned to the remote client. Our goal is to manage the shape of the client perceived response time distribution for all offered load.

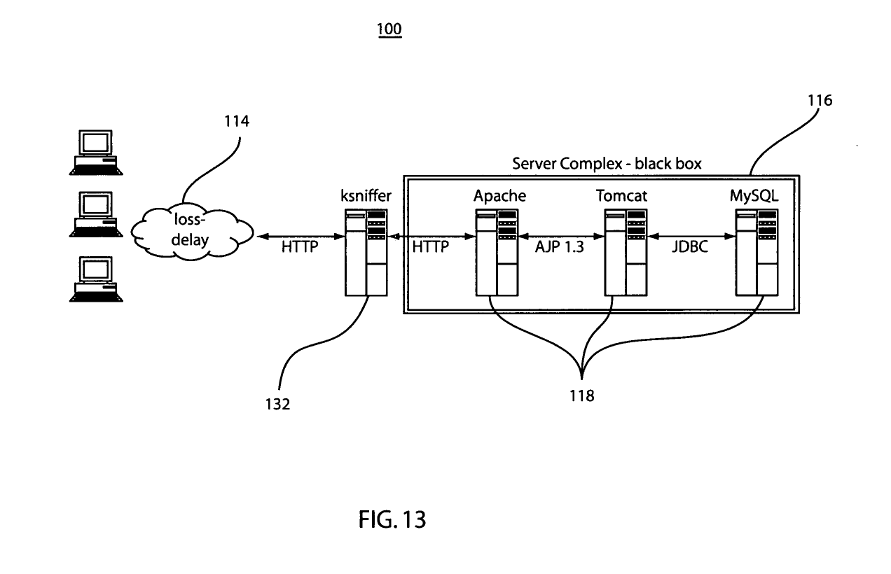

Referring to FIG. 13, an experimental test system 100 is shown in accordance with one implementation used in obtaining results in accordance with present principles. System 100 includes a response manager or ksniffer 132 connected to a network 114. A server complex 116 includes a plurality of servers 118. Servers 118 for the following test included Apache™, Tomcat™ and MySQLT™ servers as will be explained in greater detail below.

TPC-W is a transactional web e-Commerce benchmark which emulates an online book store. We used a popular Java implementation of TCP-W but made several modifications to the client code (e.g., emulated browser or EB) to make it behave like a real web browser. Although the HTTP request header sent by the EB to the server contained HTTP/1.1, the EB was actually using one connection for each GET request. The EB was emulating HTTP/1.0 behavior by opening a connection, sending the request, reading the response and closing the connection. We modified the EB code to behave like Internet Explorer™ (IE)—using two persistent connections over which the container object, then embedded objects are retried. These connections were not closed by the client but remained open during the client think periods (as per the behavior of IE). We also modified the EB so that it behaved as IE does under connection failure as depicted in FIG. 6. We used Internet protocol (IP) aliasing so that each individual EB could obtain its own unique IP address. To emulate wide-area conditions. We installed a modified version of a rshaper bandwidth shaping tool (known in the art) on each of the three client machines. rshaper supports packet loss and transmission latencies for both inbound and outbound traffic.

Apache™ was installed as the first tier HTTP server; Apache Tomcat™ was employed as the 2^{nd} tier application server (servlet engine); and MySql™ was used as the backend database. Depending on the experiment Apache™ 2.0.55 was configured to run 600 to 1200 server threads using the worker multi-processing module configuration. Tomcat™ 5.5.12 configured to maintain a pool of 1500 to 2000 AJP 1.3 server threads to service the requests from apache. TomcatT™ was also configured to maintain a pool of 1000 persistent JDBC connections to the MySQL™ server. MySQL™ 1.3 was set to the default configuration with the exception that the max_connections was changed from 100 to accommodate the persistent connections from Tomcat™.

The three client machines were all IBM® IntelliStation™ M Pro 6868 with 512 RAM and a 1.0 GHzP3. The Apache™ machine was an IBM IntelliStation™ M Pro 6868 with 1 GB RAM and a 1.0 GHzP3. The Tomcat™ machine was an IBM IntelliStation™ M Pro 6849 with 1 GB RAM and a 1.7 GHzP4. The MySQL™ machine was an IBM IntelliStation™ 6850 with 768 MB RAM and a 1.7 GHz Xeon. The entire set of machines were linked via 100 Mbps ethernet switches (netGear™, CentreCOM™ and Dell™). The ksniffer box is identical, hardware wise, to the DB server. All machines were running RedHat Linux™ v2.4 or v2.6.

The TPC-W e-Commerce application included a set of 14 servlets. Each page view download included the container page and a set of embedded gifs. All container pages were built dynamically by one of the 14 servlets running within Tomcat. First, the servlet performs a database (DB) query to obtain a list of items from one of more DB tables, then the container page is dynamically built to include that list of items as references to embedded images. After the container page is sent to the client, the client parses it to obtain the list of embedded gifs, which are then retrieved from Apache™. As such, all gifs are served by the front end Apache™ server, and all container pages are served by Tomcat™ (and MySQL™).

Client Perceived Response Time Distribution under Network Latency and Loss: We began by developing a set of baselines for our experimental system under light load (400 clients)—the DB server, which is the bottleneck resource in our multi-tier complex, is executing at 60-70% load. We incrementally added network RTT and then network drops to show the effect this has on the RT distribution. We then increased the load to a point in which the response time indicates that a quality of service mechanism would be warranted.

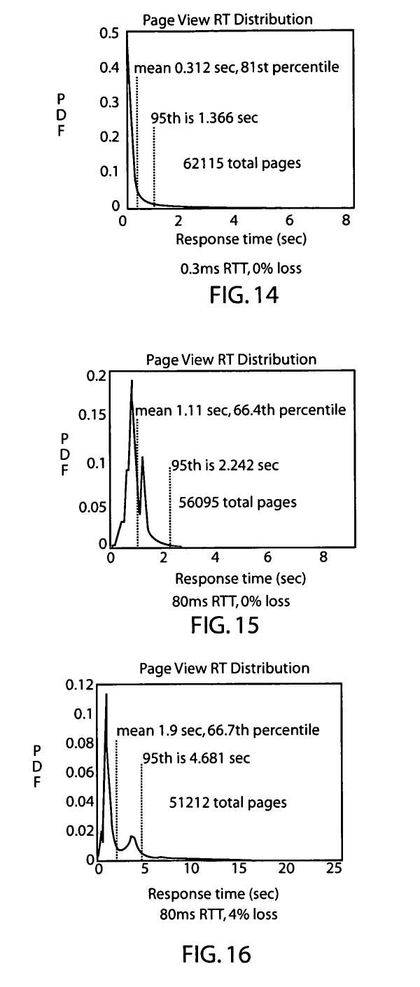

FIG. 14 shows the RT distribution under no network delay or loss. This type of configuration (no packet loss or delay) is often used in experimental settings for web server performance benchmarking and QoS experimentation.

Unfortunately, it is a very unrealistic scenario for an Internet web site being accessed by remote clients. FIG. 15 shows the RT distribution under 80 ms RTT, but no network loss. The addition of the RTT shifts and spreads the distribution to the right.

The T_{Transfer} latency now becomes more significant due to the longer RT—larger page views we take longer to download than smaller page views. FIG. 16 shows the RT distribution under 80 ms RTT and a 4% network loss rate (2% loss rate, in both directions). Once again, the server is not under heavy load and hence not dropping SYNs but of course the network is. Note the clearly distinguishable spike just after 3 s which is the result of SYN (or SYN/ACK) drops in the network. Although loss during TCP data transfer affects the transmission latency, the spike is due to the 3 s, 6 s, 12 s exponential backoff experienced by the client when SYN are dropped. The spike at 3 s is attributed to either the first or second connection of the page view having an initial SYN drop in the network.

It is the RT distribution in FIG. 16 and not the one shown in FIG. 14 which best depicts the actual shape of the RT distribution for remote clients accessing a web site on the Internet. Any approach which claims to manage client perceived response time for Internet web service ought to be verified under conditions found in the Internet: network latency and loss.

Load Shedding via Admissions Control: FIG. 16 depicts the response time achieved by our system under a reasonable load where the DB server is executing at 60% utilization. We increased the load from 400 clients to 900 clients to obtain an overloaded system for which one would like to apply a service level control mechanism. By more than doubling the number of clients the mean client perceived response time changed from 1.9 s to 5.5 s.

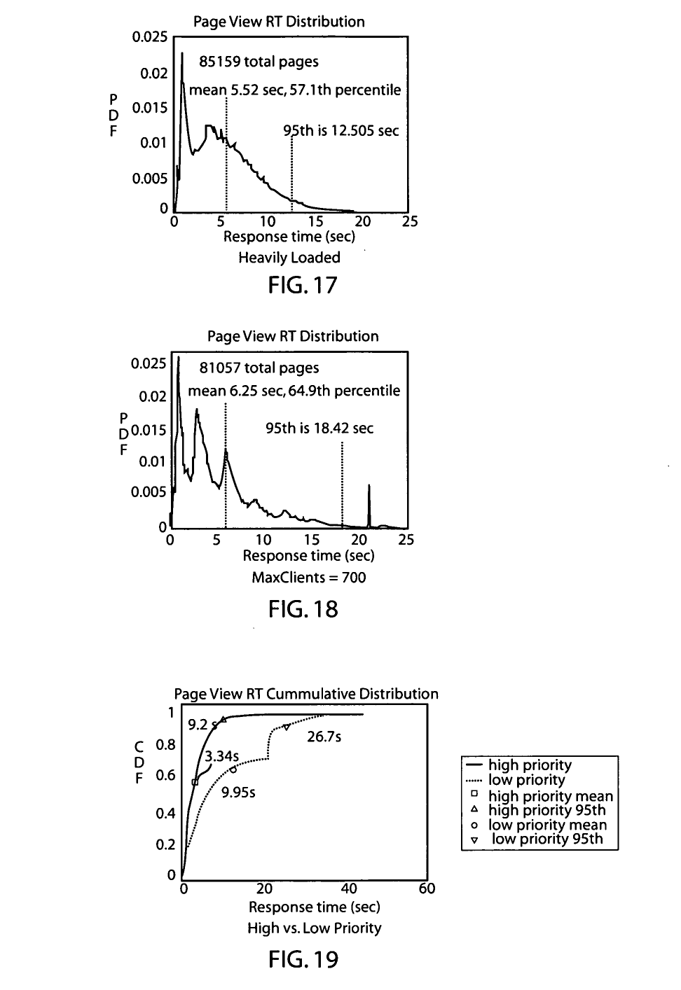

FIG. 17 shows the RT distribution under this high load. Note that no SYN drops are occurring at the server complex—the only SYNs being dropped are those being lost in the network. The percentage of SYN drops is the same for both FIG. 16 (light load) and FIG. 17 (high load). Likewise, bandwidth is at an extremely low utilization throughout the entire testbed (FIG. 13). The increase in response time is due to increased CPU utilization within the multi-tier complex.

In such a scenario, it is usually desirable to apply a load shedding technique to prevent the web server from overloading or to simply improve server response time by reducing the load. We apply one such common technique which is to limit the number of simultaneous connections being served. The simplest mechanism for performing this load shedding technique is to manipulate the Apache™ setting for MaxClients. MaxClients is an upper bound on the number of httpd threads available to service incoming connections; it bounds the number of simultaneous connections being serviced by Apache™.

FIG. 18 depicts the result after lowering the number of simultaneous connections from 1100 to 700 for the workload depicted in FIG. 17. The spike at 3 s in the distribution, as mentioned before, represents those page views which incurred an initial SYN drop resulting in a 3 s timeout on one of the two EB connections to the server. The spike at 6 s, which is barely visible in FIG. 16 but pronounced in FIG. 18, represents those page views which incurred a 3 s timeout on both connections to the server. The spike at 21 s represents those clients which experienced a connection failure. Table 1 depicts the results for throttling the number of simultaneous connections at several levels.

TABLE 1
Lead shedding via limiting the number of
simultaneous connections.

| Max | mean | 95^{th} | Tomcat | | server |
|---|---|---|---|---|---|
| Clients | PV RT | percent | RT | PV/s | SYN drops |
| 1100 | 5.9s | 13.1s | 3.8s | 55.3 | 0% |
| 1000 | 5.3s | 12.1s | 2.8s | 58.7 | 1.2% |
| 900 | 5.5s | 12.8s | 2.12s | 57.0 | 4.7% |
| 800 | 5.1s | 13.5s | 0.57s | 59.2 | 10.6% |
| 700 | 6.3s | 18.4s | 0.23s | 54.0 | 21.8% |
| 600 | 8.0s | 22.7s | 0.12s | 47.9 | 24.4% |

We instrumented the TPC-W servlets to capture their response time by taking a timestamp when the servlet was called and a timestamp when the servlet returned; this covers the time it takes to build the container page, including the DB query but does not include the time to connect to the server complex or transmit the response. As shown in Table 1, as the number of simultaneous connections decreases, the time to query the DB and create the container page decreases, but the overall page view response time increases due to SYN drops. Some clients are experiencing response times which can be considered as better than required while other clients are experiencing significant latencies due to SYN drops.

This mechanism is effective in reducing server response time but when measuring on a page view level, and including those pages which experienced the default admissions control drops, the mean page view response time actually increases. The significant effect that SYN drops have on the response time distribution makes providing service level agreements based on meeting a threshold for the 95^{th} percentile impossible to achieve.

In a multi-class QoS environment, it is desirable to maintain a specific RT threshold for a certain class of clients. Given a finite set of resources under a heavy load (as in FIG. 17) this implies that low priority clients will suffer and receive worse RT than if all clients were treated equally. Conversely, high priority clients are expected to benefit and receive better response time than if all clients were treated equally.

We apply a multi-class load shedding technique that is commonly used to achieve multi-class response time goals which is to perform SYN throttling for admissions control. SYNs arriving from low priority clients are dropped when the high priority clients are exceeding their RT threshold. Given that clients from subnet 10.4.*.* are high priority clients, we engage the following rule within ksniffer:

IF IP.SRC! = 10.4.*.* AND RT_HIGH > 3.0s THEN
DROP SYN

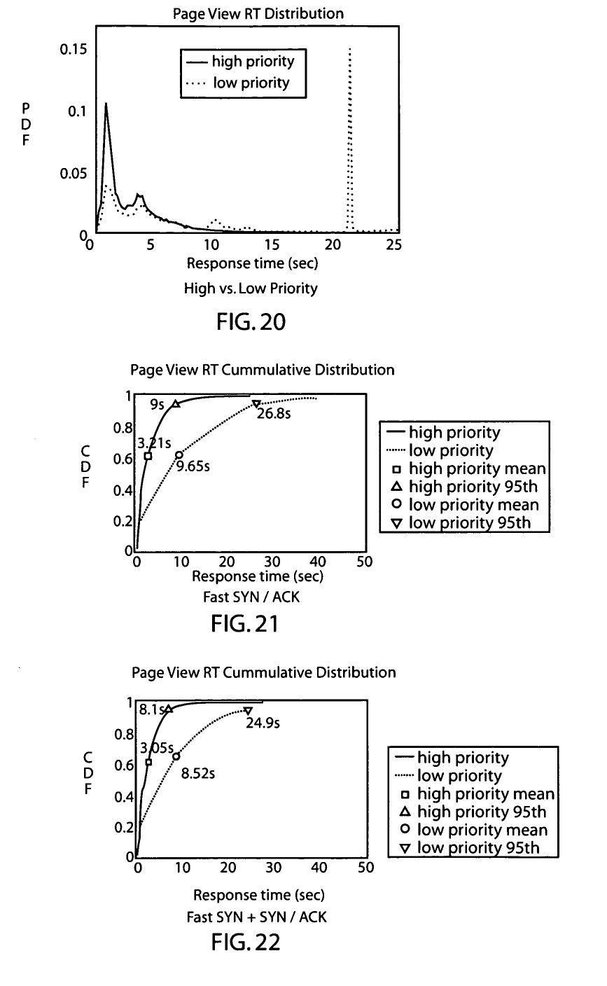

FIG. 19 shows that mean response time for the 300 high priority clients was adjusted to 3.34 s, but at a heavy cost to the 600 low priority clients. The vertical jump at 21 s for the low priority clients indicates the set of connection failures experienced by those clients. This is seen in FIG. 20 which compares the RT distribution of the high and low priority clients.

Although we set the page view response time goal for high priority clients to 3 s, we only achieved a mean RT of 3.34 ss, which is an error of 11.3%. The reason for this is that some clients within the high priority class are experiencing SYN/ACK drops in the network. To alleviate this effect we configured ksniffer to perform fast SYN/ACK retransmissions:

IF IP.SRC = 10.4*.* THEN FAST SYN/ACK
IF IP.SRC! = 10.4.*.* AND RT_HIGH > 3.0 THEN
DROP SYN

As shown in FIG. 21, this reduces the error down to 7%-SYNs dropped at the server are still affecting the RT. After applying both fast SYN and fast SYN/ACK retransmission, we are able to meet our goal of 3 s (FIG. 22):

IF IP.SRC = 10.4.*.* THEN FAST SYN + SYN/ACK
IF IP.SRC! = 10.4.*.* AND RT_HIGH > 3.0S THEN
DROP SYN

Since fast SYN/ACK only becomes relevant once the server accepts a SYN, it could be applied indiscriminately to all service classes. To demonstrate, we extend the previous rules by introducing a third class of service:

```
IF IP.SRC = *.*.*.* THEN FAST SYN/ACK
IF IP.SRC = 10.4.*.* THEN FAST SYN
IF IP.SRC = 10.3.*.* AND RT_HIGH < 3.0S THEN
    FAST SYN
ELSE DROP SYN
IF IP.SRC = 10.2.*.* AND RT_HIGH <
    AND RT_MID < 6.0S THEN FAST SYN
ELSE DROP SYN
```

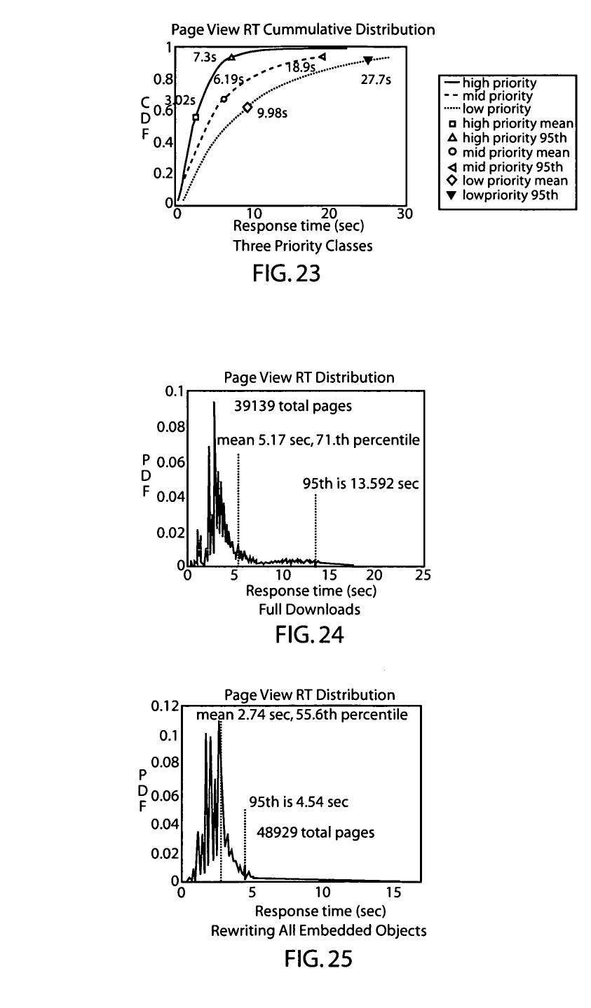

All clients receive fast SYN/ACK, but only high priority clients from 10.4.*.* always receive fast SYN. If high priority clients are not meeting their RT goals of 3 s, then SYNs from mid and low priority clients are dropped, without fast SYN+SYN/ACK retransmit. If mid priority clients from 10.3.*.* are not meeting their RT goals of 6 s, then SYNs from low priority clients are dropped, without fast SYN and fast SYN/ACK retransmit. FIG. 23 shows high and mid priority client achieving their RT goals and that only the low priority clients from 10.2.*.* experience a small number of connection failures. As above, extended ksniffer applies this rule during the transitions from state 1→2, and from state 7→8 (FIG. 4). Variations on the basic concept of fast SYN and fast SYN/ACK include adjusting the retransmission timer gap based on a number of parameters: client priority, RTT to the client remote subnet, or adjusting it dynamically w.r.t. server load.

Managing Latency Due to RTT and loss: Previously, we presented a situation where the load on the system was severely affecting the RT. Now, we discuss our techniques for affecting the page view latency when load shedding would have no affect—under situations of large RTT and network loss.

We modified our environment by increasing the client RTT from 80 ms to 300 ms, and we reduced the number of clients from 900 to 400 to ensure that the DB server was no longer the bottleneck. The RT distribution for this scenario is shown in FIG. 24. In this environment nothing in the server complex is overloaded, and no server side SYN drops are occurring. As such, load shedding performed at the server will not have an affect on the RT.

To determine the maximal effect that embedded image rewrite would have on RT, we configured ksniffer to rewrite all embedded images from the client to the server:

### IF IP.SRC=*.*.*.* THEN REWRITE EMBEDS

Each URL request for an embedded object was captured and rewritten specifying a smaller object. This can be done whenever ksniffer receives an HTTP request: e.g., states 6, 8, and 11 in FIG. 4. The results shown in FIG. 25 indicate that a significant improvement in RT can be achieved using this technique in situations where load shedding is inapplicable. The downside to embedded object rewrite is that the subjective quality of the page view is affected. Just as fast SYN and fast SYN/ACK can be applied discriminantly, so can embedded object reduction. As such, its application can be based on both a fidelity and response time goal.

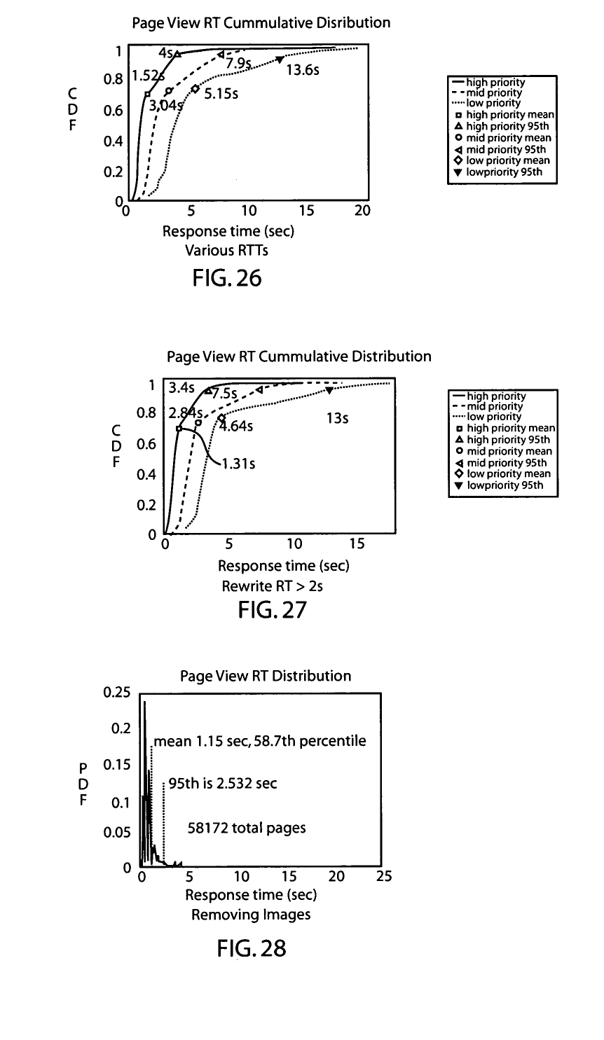

We split our clients into three groups, one having 60 ms RTT, another with 160 ms RTT and the third with 300 ms RTT. FIG. 26 depicts their respective response times when downloading entire page views: containers and images. By default, the difference in RTT separates out the clients into three service classes when only one class of service is desired. We incrementally apply image rewriting by applying the following rule to the configuration in FIG. 26. The result is shown in FIG. 27:

### IF RT>2 s THEN REWRITE EMBEDS

Unlike the previous section where the decision to drop a SYN or apply fast SYN and fast SYN/ACK was made based on the RT for a class of clients, here the decision is being made on a per page view basis, based on the elapsed time for that specific page view down. We chose 2 s as the threshold to achieve a RT slightly larger than that. Although the requests are much smaller than the original objects, the RTT still comes into play during the embedded object downloads. As such, this technique needs more modeling to determine the point at which rewriting should begin to be applied to achieve a specific RT for that page. This depends on the RTT, loss and number of remaining objects left to obtain.

Embedded object rewrite is effective, but still incurs the latencies associated with Tₛₑᵣᵥₑᵣ, T_{transfer}, T_{render} and possibly T_{conn}—although the objects are much smaller, they still have to be processed. In another technique, embedded object removal, eliminates these latencies. To determine the maximal effect this technique has on the page view response time we configured ksniffer to perform embedded object removal for all page views:

### IF IP.SRC=*.*.*.* THEN REMOVE EMBEDS

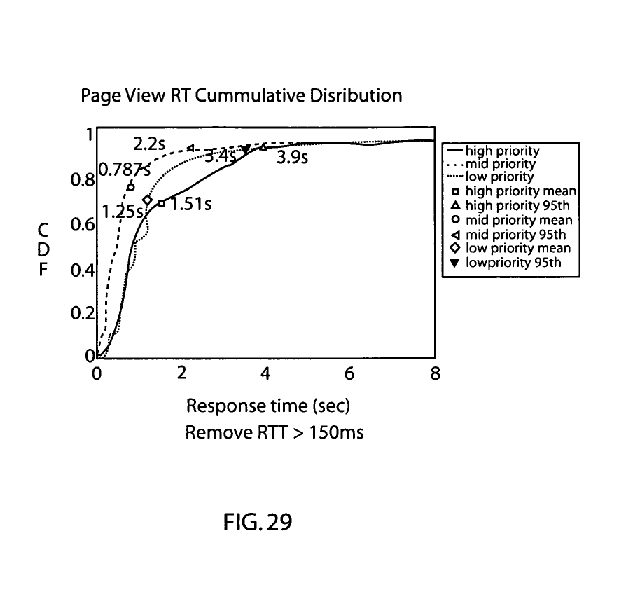

Each reference to an embedded image was blanked out of the HTML during transition 3→4 (FIG. 4). The result is depicted in FIG. 28. We verified this is the same result if we configure the traffic generator to ignore embedded objects when downloading a page view. Embedded object removal is more effective at reducing response time than embedded object rewrite, but the effect is coarse-grained. The removal of the references to embedded objects occurs during the transition 3→4 (FIG. 4). This essentially eliminates states 6 thru 18 (FIG. 4). FIG. 29 depicts the effect of configuring ksniffer to remove the embedded objects from a container page if the RTT for that client is measured to be greater than 150 ms:

### IF RTT>150 MS THEN REMOVE EMBEDS

Referring back to FIG. 4, the measure of RTT is obtained during connection establishment, the transition from 1→2. Comparing FIG. 29 to FIG. 26, the clients with an RTT of 60 ms are unaffected and maintain their current response times. Clients with an RTT of 160 ms experienced a decrease in mean response time from 3.04 s to 0.787 s; likewise the clients with an RTT of 300 ms dropped from 5.15 ms to 1.25 ms. Note that one would not expect the distribution of the 160 ms RTT clients and the 300 ms RTT clients to appear similar in FIG. 29. Even though they both had their embedded images removed, their RTTs are significantly different. The difference in RTT still affects TCP connection establishment and the container page download latencies. As mentioned earlier, this technique could be applied selectively—as per policy, specific, less important images could be removed from the container page.

The work presented is unique in regard to the ability to track a page view download as it occurs, properly measure its elapsed response time as perceived by the remote client, decide if action ought to be taken at key junctures during the download and apply latency control mechanisms for the current activities. To our knowledge, this is also the first work to examine how web browsers behave under failure conditions and how that affects the client perceived response time. Wei et al, in “Provisioning of Client-perceived End-to-end QoS Guarantees in Web Servers”, International Workshop on Quality of Services (IQWoS) 2005), seeks to measure and control the page view response time. Wei employs a self-tuning fuzzy controller to adjust the number of simultaneous connections being services for each class of. The RT measurement module is based on ideas from ksniffer but differs in that it tracts the activity between client and Apache in user space by intercepting socket level transactions made by Apache. As such, it is unable to detect packet loss and measure RTT, and requires modifications within the server complex. Among of differences, the system is independent from, and not coordinated with, any admission control mechanism, which they suggest ought to be used under heavy load.

Remote Latency-based Management (RLM) includes a novel approach for managing the client perceived response time of a web server. RLM manages the response time as perceived by the remote client for an entire page download by tracking, online, the progress of a page view and making service decisions at each key juncture. RLM takes into account the effect of admissions control rejects, something rarely considered when applying load shedding to achieve service level agreements. In this vein, the present embodiments are able to uncover some notable effects that occur in web browsers under conditions of connection failures and introduce a novel mechanism, fast SYN+SYN/ACK retransmission, which can be used in the context of load shedding to combat these effects. The approach presented is non-invasive and manipulates the latencies experienced at the remote web browser by manipulating the packet traffic in/out of a server complex—without requiring any changes to existing systems.

Service decisions during the course of a page view download are based on elapsed time. A prediction of the remaining work required to complete the page view download (i.e. number/size of the remaining embedded objects and their expected processing latency) may be made. Orthogonal to page view response time management is the development of traffic generators which accurately mimic the behavior of real web browsers in all aspects of behavior. This would entail a more comprehensive analysis of how web browsers behave under all conditions.

Having described preferred embodiments of a system and method for management of client perceived page view response time (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for managing perceived response time, comprising:
transmitting a request or response;
if the request or response is dropped, managing response time by providing a retransmission from a response time manager, without the response time manager satisfying the request or response, the response time manager being located between a client and a server.

2. The method as recited in claim 1, wherein managing the response time is performed based on downloading of an entire page.

3. The method as recited in claim 2, further comprising tracking progress of the downloading of the entire page as each of a plurality of objects is downloaded; and making decisions by the response time manager to control perceived response time based upon download latencies of portions of the entire page.

4. The method as recited in claim 1, wherein the request or response includes transmitting from the response time manager a fast SYN retransmission on behalf of the client, where the retransmission timeout is less than a standard exponential backoff time.

5. The method as recited in claim 1, wherein the request or response includes transmitting from the response time manager a fast SYN/ACK retransmission on behalf of the server, where the retransmission timeout is less than a standard exponential backoff time.

6. The method as recited in claim 1, further comprising substituting objects of lesser size for requested objects of larger size.

7. The method as recited in claim 1, further comprising removing references to at least one embedded object.

8. A method for managing perceived response time, comprising:
tracking progress of downloading of an entire page as each of a plurality of objects is downloaded; and
managing response latency using a response time manager to control perceived response time based upon download latencies of portions of the entire page.

9. A computer program product for managing perceived response time comprising a computer useable medium including a computer readable program, wherein the computer readable program when executed on a computer causes the computer to perform the steps of:
transmitting a request or response;
if the request or response is dropped, managing response time by providing a retransmission from a response time manager, without the response time manager satisfying the request or response, the response time manager being located between a client and a server.

10. The computer program product as recited in claim 9, further comprising tracking progress of downloading of an entire page as each of a plurality of objects is downloaded; and making decisions by the response time manager to control perceived response time based upon download latencies of portions of the entire page.

11. A system for managing perceived response time, comprising:
a response time manager disposed between a network and a server, the response time manager configured to manage perceived response time by retransmitting a dropped response or request; and
a response module included in the response manager and configured to monitor perceived response times of a client and make adjustments to processing of requests or responses to reduce overall latency.

12. The system as recited in claim 11, wherein the response time manager is located in front of the server on a server side and manipulates a packet stream between the server and a client to manage packets therebetween to control client latency.

13. The system as recited in claim 11, wherein the response time manager provides one of a plurality of actions based upon preset junctures in a communication session between the client and the server.

14. The system as recited in claim 11, wherein the response module is configured to track progress for downloading of an entire page as each of a plurality of objects is downloaded, and makes decisions to control perceived response times based upon latencies of portions of the entire page.

15. The system as recited in claim 11, wherein the response module includes a response mechanism, the response mechanism being triggered to transmit a response on behalf of one of the client and the server.

16. The system as recited in claim 15, wherein the response mechanism includes a fast SYN retransmission on behalf of the client, where the retransmission timeout is less than a standard exponential backoff time.

17. The system as recited in claim 15, wherein the response mechanism includes a fast SYN/ACK retransmission on behalf of the server, where the retransmission timeout is less than a standard exponential backoff time.

18. The system as recited in claim 11, wherein the response module substitutes objects of lesser size for requested objects of larger size.

19. The system as recited in claim 11, wherein the response module removes references for at least one embedded object from the response or request.
